(19) United States
(12) Patent Application Publication
(10) Pub. No.: US 2002/0197561 A1
(43) Pub. Date: Dec. 26, 2002

(54) Optical data carrier comprising a cyclizable compound in the information layer

(76) Inventors: Horst Berneth, Leverkusen (DE); Friedrich-Karl Bruder, Krefeld (DE); Wilfried Haese, Odenthal (DE); Rainer Hagen, Leverkusen (DE); Karin Hassenruck, Dusseldorf (DE); Serguei Kostromine, Swisttal (DE); Peter Landenberger, Koln (DE); Rafael Oser, Krefeld (DE); Thomas Sommermann, Bergisch Gladbach (DE); Josef-Walter Stawitz, Odenthal (DE); Thomas Bieringer, Odenthal (DE)

Correspondence Address: BAYER CORPORATION, PATENT DEPARTMENT, 100 BAYER ROAD, PITTSBURGH, PA, 15205, US

(21) Appl. No.: 10/102,582

(22) Filed: Mar. 20, 2002

(30) Foreign Application Priority Data
Mar. 28, 2001 (DE) 10115227.2
Apr. 6, 2001 (DE) 10117464.0
Jan. 9, 2002 (DE) 10200484.6

(51) Int. Cl. G11B 7/24

(52) U.S. Cl. 430/270.15; 430/945; 428/64.8; 369/284

(57) ABSTRACT

Optical data carrier comprising a preferably transparent substrate which may, if desired, have previously been coated with a protective layer and to whose surface a light-writable information layer, if desired a protective layer, if desired an adhesive layer and finally a covering layer have been applied, which can be written on and read by means of blue light, preferably laser light, where the information layer comprises a light-absorbent compound, characterized in that at least one dye which cyclizes thermally is used as light-absorbent compound.

The invention relates to a write-once optical data carrier comprising a cyclizable, light-absorbent compound in the information layer, to a process for producing the optical data carriers, to their use and to novel cyclizable light-absorbent compounds and also to the application of the above-mentioned dyes to a polymer substrate, in particular polycarbonate, by spin coating or vapour deposition.

Write-once optical data carriers using specific light-absorbent substances or mixtures thereof are particularly suitable for use in high-density writeable optical data stores which operate with blue laser diodes, in particular GaN or SHG laser diodes (360-460 nm) and/or for use in DVD-R or CD-R disks which operate with red (635-660 nm) or infrared (780-830 nm) laser diodes.

The write-once compact disk (CD-R, 780 nm) has recently experienced enormous volume growth and represents the technically established system.

The next generation of optical data stores—DVDs—is currently being introduced onto the market. Through the use of shorter-wave laser radiation (635-660 nm) and higher numerical aperture NA, the storage density can be increased. The writeable format in this case is DVD-R.

Today, optical data storage formats which use blue laser diodes (based on GaN, JP 08 191 171 or Second Harmonic Generation SHG JP 09 050 629) (360 nm-460 nm) with high laser power are being developed. Writeable optical data stores will therefore also be used in this generation. The achievable storage density depends on the focusing of the laser spot on the information plane. Spot size scales with the laser wavelength λ/NA. NA is the numerical aperture of the objective lens used. In order to obtain the highest possible storage density, the use of the smallest possible wavelength λ is the aim. At present 390 nm is possible on the basis of semiconductor laser diodes.

The patent literature describes dye-based writeable optical data stores which are equally suitable for CD-R and DVD-R systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs is located at the foot of the short wavelength flank of the absorption peak of the dye. In JP-A 02 557 335, JP-A 10 058 828, JP-A 06 336 086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writeable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapour deposition and/or sublimation during subsequent covering with metallic or dielectric layers under reduced pressure.

The amorphous layer comprising light-absorbent substances preferably has a high heat distortion resistance, since otherwise further layers of organic or inorganic material which are applied to the light-absorbent information layer by sputtering or vapour deposition would form blurred boundaries due to diffusion and thus adversely affect the reflectivity. Furthermore, a light-absorbent substance which has insufficient heat distortion resistance can, at the boundary to a polymeric support, diffuse into the latter and once again adversely affect the reflectivity.

A light-absorbent substance whose vapour pressure is too high can sublime during the above-mentioned deposition of further layers by sputtering or vapour deposition in a high vacuum and thus reduce the layer thickness to below the desired value. This in turn has an adverse effect on the reflectivity.

It is therefore an object of the invention to provide suitable compounds which satisfy the high requirements (e.g. light stability, favourable signal/noise ratio, damage-free application to the substrate material, and the like) for use in the information layer in a write-once optical data carrier, in particular for high-density writeable optical data store formats in a laser wavelength range from 360 to 460 nm.

Surprisingly, it has been found that cyclizable, light-absorbent compounds can satisfy the abovementioned requirement profile particularly well.

The invention accordingly provides an optical data carrier comprising a preferably transparent substrate which may, if desired, have previously been coated with a protective layer and to whose surface a light-writable information layer, if desired a protective layer, if desired an adhesive layer and finally a covering layer have been applied, which can be written on and read by means of blue light, preferably laser light, particularly preferably light having a wavelength of 360-460 nm, in particular 380-440 nm, very particularly preferably 395-415 nm, where the information layer comprises a light-absorbent compound and, if desired, a binder, characterized in that the light-absorbent compound has a chemical structure which cyclizes thermally to 5-, 6- or 7-membered rings during the writing process.

The thermal cyclization of the chemical structure of the light-absorbent compound should preferably result in a shift of the local absorption maximum in the range 350-470 nm. In particular, the shift is more than 25 nm (Δλ max), particularly preferably more than 35 nm, very particularly preferably more than 45 nm. The shift is preferably hypsochromic.

The thermal change preferably occurs at a temperature of <600° C., particularly preferably at a temperature of <400° C., very particularly preferably at a temperature of <300° C., in particular <200° C.

Likewise, thermal cyclization preferably occurs only at a temperature of >100° C., in particular >140° C., preferably >180° C.

The cyclization temperature T_{cyc} is determined, for example, by means of Differential Thermal Analysis DTA. In the case of the preferred exothermic cyclization, it corresponds to the maximum of the rearrangement signal. The heating rate in the DTA measurements is, for example, 10° C. per minute. Under these conditions, the width at half height of the rearrangement signal is preferably less than 10° C., particularly preferably less than 7° C., very particularly preferably less than 5° C. For the purposes of the invention, the width at half height is the width of the signal at a height halfway between the base and the apex.

As light-absorbent compound, preference is given to a compound which has a chemical structure which can cyclize thermally to 5-, 6- or 7-membered rings.

The light-absorbent compound used is particularly preferably a compound of the formula (I) or (II),

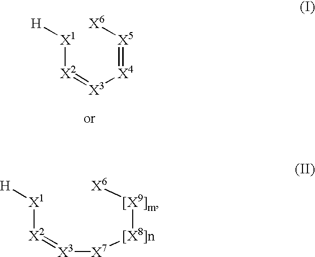

where

X¹ represents NR¹, O or S,

X² represents CR² or N,

X³ represents CR³ or N,

X⁴ represents CR⁴ or N,

X⁵ represents CR⁵ or N, where the sequence X²-X³-X⁴-X⁵ has no adjacent N atoms,

X⁶ represents CR⁶R⁷R⁸, CR⁹═O, CR¹⁰═S, CR¹¹═NR¹² or C≡N,

X⁷ represents CR¹³R¹⁴ or C═R¹⁵,

X⁸ represents O, NR¹⁶, CR¹⁷R¹⁸ or C═R¹⁹,

X⁹ represents O, NR²⁰, CR²¹R²² or C═R²³, where X⁹ does not represent O when X⁸ represents O,

n, m represent, independently of one another, 0 or 1,

R¹ represents hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,

R² represents hydrogen, bromine, C₁-C₆-alkyl, C₁-C₆-alkenyl, C₁-C₆-alkynyl, C₆- C₁₀-aryl, C₇-C₁₅-araryl, hetaryl, C₁-C₆-alkoxy, mono- or di-C₁-C₆-alkylamino, N-C₁-C₆-alkyl-N-C₆-C₁₀-arylamino or together with R¹ is part of a five- or 6-membered aromatic or partially hydrogenated ring which may contain from 1 to 4 hetero atoms or carbonyl groups and/or may be benzo- or naphtho-fused and/or substituted by nonionic, preferably electron donor radicals,

R³ represents hydrogen, C₁-C₆-alkyl, C₁-C₆-alkenyl, C₆-C₁₀-aryl, C₇-C₁₅-araryl, hetaryl, C₁-C₆-alkoxycarbonyl, formyl, cyano, nitro, halogen or together with R² is part of a five- or 6-membered aromatic or partially hydrogenated ring which may contain from 1 to 4 hetero atoms or carbonyl groups and/or may be benzo- or naphtho-fused and/or have its rings substituted by nonionic radicals,

R⁴ represents hydrogen, amino, bromine, C₁-C₆-alkyl, C₁-C₆-alkenyl, C₁-C₆-alkynyl, C₆-C₁₀-aryl, C₇-C₁₅-araryl, hetaryl, C₁-C₆-alkoxy, C₁-C₆-thioalkoxy, mono- or di-C₁-C₆-alkylamino, N-C₁-C₆-alkyl-N-C₆-C₁₀-arylamino or together with R³ is part of a five- or 6-membered aromatic or partially hydrogenated ring which may contain from 1 to 4 hetero atoms or carbonyl groups and/or may be benzo- or naphtho-fused and/or substituted by nonionic, preferably electron donor radicals,

R⁵ represents hydrogen or an electron acceptor, in particular cyano, nitro, —(C═R²⁴)R²⁵, a cationic radical such as ammonium or pyridinium or together with R⁴ is part of a five- or 6-membered aromatic or partially hydrogenated ring which may contain up to 4 hetero atoms or carbonyl groups and/or may be benzo- or naphtho-fused and/or substituted by nonionic radicals,

R⁶ represents hydrogen, bromine, chlorine, methoxy or ethoxy,

R⁷ represents hydrogen, bromine, chlorine or represents methoxy when R⁶ represents methoxy or represents ethoxy when R⁶ represents ethoxy,

R⁸ represents bromine, chlorine, iodine, cyano, tosylate, triflate, C₁-C₆-alkanoyloxy, C₁-C₆-alkylthio or represents methoxy when R⁷ represents methoxy or represents ethoxy when R⁷ represents ethoxy,

R⁹, R¹⁰ and R¹¹ represent, independently of one another, C₁-C₆-alkoxy, chlorine, bromine, iodine, C₁-C₆-alkanoyloxy, C₁-C₆-alkylthio, C₆-C₁₀-aryloxy, C₆-C₁₀-arylcarbonylamino or one of these radicals together with R⁵ is part of a five- or 6-membered aromatic or partially hydrogenated ring which may contain carbonyl groups or from 1 to 4 hetero atoms and/or may be benzo- or naphtho-fused and/or substituted by nonionic radicals,

R¹² represents hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,

R¹³, R¹⁴, R¹⁷, R¹⁸, R²¹ and R²² represent, independently of one another, hydrogen, C₁-C₃-alkyl, fluorine, chlorine or bromine,

R¹⁵ represents O, S, ═NR²⁶ or CR²⁷R²⁸,

R¹⁶ and R²⁰ represent, independently of one another, hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,

R¹⁹ represents O, S, ═NR²⁹ or CR³⁰R³¹,

R represents O, S, ═NR³², CR³³R³⁴,

R represents O, S or NR³⁵,

R²⁵ represents bromine, amino, N-C₁-C₆-alkylamino, di-N-C₁-C₆-alkylamino, N-C₁-C₆-alkyl-N-C₆-C₁₀-arylamino, C₁-C₆-alkanoyloxy, C₆-C₁₀-aryloxy, C₁-C₆-alkyl, C₁-C₆-alkoxy, C₁-C₆-alkylthio or together with X⁶ is part of a 5- or 6-membered ring,

R²⁶, R²⁹, R³² and R³⁵ represent, independently of one another, hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals and

R²⁷, R²⁸, R³⁰, R³¹, R³³ and R³⁴ represent, independently of one another, hydrogen, C₁-C₆-alkyl, C₁-C₆-alkenyl, C₄-C₇-cycloalkyl, C₇-C₁₅-aralkyl, aryl or hetaryl, where the hetaryl radical can contain up to 3 hetero atoms and the aryl or hetaryl radical may be substituted by up to 3 nonionic radicals.

The thermal cyclization product of the compound of the formula (I) has the formula (Ia), and that of the compound of the formula II has the formula (IIa)

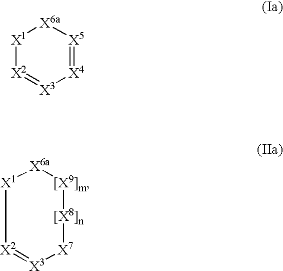

where

X¹, X², X³, X⁴, X⁵, X⁷, X⁸, X⁹, n and m are as defined above,

X^{6a} represents CR⁶R⁷, CO, CS, C═NR¹² or C═NH,

where

R⁶, R⁷ and R¹² are as defined above.

Both the compounds of the formula (Ia) and those of the formula (IIa) are likewise subject-matter of the invention.

Possible nonionic radicals are, for example, C₁-C₄-alkyl, C₁-C₆-alkoxy, halogen, cyano, nitro, C₁-C₄-alkoxycarbonyl, C₁-C₄-alkylthio, C₁-C₄-alkanoyl amino, benzoylamino, mono- or di-C₁-C₄-alkylamino, C₁-C₆-alkanoyloxy, 1-(1,2,3)-triazole and 2-(1,2,3)-triazole.

Examples of electron donor radicals are C₁-C₄-alkoxy, C₆-C₁₀-aryloxy, mono- or di-C₁-C₆-alkylamino, N-C₁-C₆-alkyl-N-C₆-C₁₀-arylamino.

Possible hetaryl groups are, for example, pyrrole, thiophene, furan, oxazole, isoxazole, imidazole, pyrazole, thiazole, isothiazole, pyridine, pyrimidine, pyridazine, pyrazine, 1,2,3-triazole, 1,2,4-triazole and their benzo-fused analogues.

For the purposes of the invention, hetaryl includes piperidine, pyrrolidine, morpholine, piperazine and chromane.

Alkyl, alkoxy, aryl and heterocyclic radicals may, if desired, bear further radicals such as alkyl, halogen, nitro, cyano, CO-NH₂, alkoxy, trialkylsilyl, trialkylsiloxy or phenyl, the alkyl and alkoxy radicals may be straight-chain or branched, the alkyl radicals may be partially halogenated or perhalogenated, the alkyl and alkoxy radicals may be methoxylated, ethoxylated or propoxylated or silylated, adjacent alkyl and/or alkoxy radicals on aryl or heterocyclic radicals may together form a three- or four-membered bridge and the heterocyclic radicals may be benzo-fused and/or quarternized.

In a particularly preferred embodiment, the light-absorbent compounds of the formula I which are used are ones which have the formula (III) (the group capable of cyclization is shown in bold type),

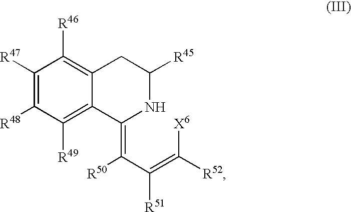

where

R⁴⁵ represents hydrogen, bromine, chlorine, C₁-C₄-alkyl, C₁-C₄-alkoxy, cyano, C₁-C₄-alkoxycarbonyl, mono- or di-C₁-C₄-alkylamino,

R⁴⁶, R⁴⁷, R⁴⁸ and R⁴⁹ represent, independently of one another, hydrogen, methyl, ethyl, C₁-C₆-alkoxy, fluorine, chlorine, bromine, cyano, nitro, C₁-C₄-alkoxycarbonyl, mono- or di-C₁-C₄-alkylamino,

R⁵⁰ represents hydrogen, methyl, cyano, C₁-C₆-alkoxycarbonyl, formyl, bromine, chlorine,

R⁵¹ represents hydrogen, methyl, bromine, amino, N-methylamino, dimethylamino, methoxy, ethoxy, —S—CH₃,

R⁵² represents cyano, C₁-C₆-alkoxycarbonyl, C₆-C₁₀-aryloxycarbonyl, C₁-C₆-alkanoyloxycarbonyl and

X⁶ represents cyano, C₁-C₆-alkoxycarbonyl, C₆-C₁₀-aryloxycarbonyl, C₁-C₆-alkanoyloxycarbonyl or —CH₂—O—SO₂-p-C₆H₄—CH₃.

Very particular preference is given to the dyes of the formula (III)

in which

R⁴⁵ represents hydrogen, methyl, ethyl, isopropyl,

R⁴⁶, R⁴⁹ represent hydrogen,

R⁴⁷, R⁴⁸ represent, independently of one another, hydrogen, C₁-C₆-alkoxy, mono- or di-C₁-C₄-alkylamino,

R⁵⁰ represents hydrogen, methyl, cyano, C₁-C₆-alkoxycarbonyl,

R⁵¹ represents hydrogen, methyl, amino, N-methylamino, dimethylamino, methoxy, ethoxy,

R⁵² represents cyano, C₁-C₆-alkoxycarbonyl, C₆-C₁₀-aryloxycarbonyl, C₁-C₆-alkanoyloxycarbonyl and

X⁶ represents cyano, C₁-C₆-alkoxycarbonyl, C₆-C₁₀-aryloxycarbonyl, C₁-C₆-alkanoyloxycarbonyl, —CH₂—O—SO₂-p-C₆H₄—CH₃.

Particularly great preference is given to light-absorbent compounds of the formula (III)

in which

R⁴⁵, R⁴⁶ , R⁴⁹ represent hydrogen,

R⁴⁷, R⁴⁸ represent, independently of one another, hydrogen, C₁-C₃-alkoxy, mono- or di-C₁-C₂-alkylamino,

R⁵⁰, R⁵¹ represent hydrogen,

R⁵² represents cyano, C₁-C₆-alkoxycarbonyl, C₁-C₆-alkanoyloxycarbonyl and

X⁶ represents cyano, C₁-C₆-alkoxycarbonyl, C₆-C₁₀-aryloxycarbonyl.

The thermal cyclization product of the compound of the formula (III) has the formula (IIIa)

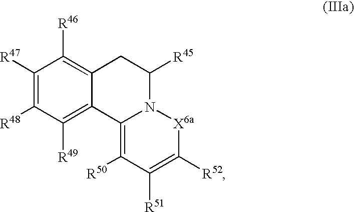

where the radicals R⁴⁵-R⁵² are as defined above and

X^{6a} represents C═NH, CO or CH₂.

In a likewise particularly preferred embodiment, the light-absorbent compounds of the formula I which are used are ones which have the formula (IV)

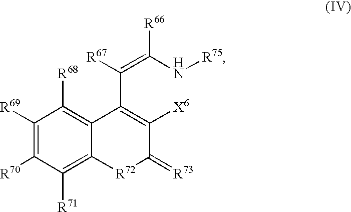

where

R⁶⁶ represents hydrogen, bromine, chlorine, C₁-C₄-alkyl, C₁-C₆-alkoxy, cyano, C₁-C₄-alkoxycarbonyl, mono- or di-C₁-C₄-alkylamino,

R⁶⁷ represents hydrogen, C₁-C₆-alkyl, C₁-C₆-alkenyl, C₆-C₁₀-aryl, C₇-C₁₅-araryl, hetaryl, C₁-C₆-alkoxycarbonyl, formyl, cyano, nitro, halogen or together with R⁶⁶ is part of a five- or 6-membered aromatic or partially hydrogenated ring which may contain from 1 to 4 hetero atoms and/or may be benzo- or naphtho-fused and/or have its rings substituted by nonionic radicals,

R⁶⁸, R⁶⁹, R⁷⁰ and R⁷¹ represent, independently of one another, hydrogen, methyl, ethyl, isopropyl, C₁-C₆-alkoxy, fluorine, chlorine, bromine, cyano, nitro, C₁-C₄-alkoxycarbonyl, mono- or di-C₁-C₄-alkylamino, C₁-C₄-alkanoyloxy or 2 adjacent radicals form a butadiene bridge,

R⁷⁰ may also represent 1,2,3-triazol-2-yl which may be benzo-fused or naphtho-fused in the 4,5 position,

R⁷² represents O, NH, N—C₁-C₃-alkyl,

R⁷³ represents O, N—C₁-C₆-alkyl, N—C₆-C₁₀-aryl,

X⁶ represents cyano, —CH₂—O—SO₂-p-C₆H₄—CH₃, —CH₂—O—SO₂—CF₃, C₁-C₆-alkoxy-carbonyl, C₆-C₁₀-aryloxycarbonyl, C₁-C₆-alkanoyloxycarbonyl and

R⁷⁵ represents hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals.

Very particular preference is given to compounds of the formula (IV)

in which

R⁶⁶ represents hydrogen, C₁-C₄-alkyl, C₁-C₆-alkoxy, cyano, mono- or di-C₁-C₄-alkylamino,

R⁶⁷ represents hydrogen, C₁-C₆-alkyl, C₆-C₁₀-aryl, hetaryl, C₁-C₆-alkoxycarbonyl, formyl, cyano, nitro, halogen,

R⁶⁸, R⁷¹ represent hydrogen,

R⁶⁸, R⁶⁹ may also form a butadiene bridge,

R⁶⁹ and R⁷⁰ represent, independently of one another, hydrogen, methyl, C₁-C₂-alkoxy, chlorine, C₁-C₂-alkoxycarbonyl, mono- or di-C₁-C₄-alkylamino, C₁-C₄-alkanoyloxy,

R⁷⁰ may also represent 1,2,3-triazol-2-yl which may be benzo-fused or naphtho-fused in the 4, 5 position,

R⁷² represents O or NH,

R⁷³ represents O,

X⁶ represents cyano, —CH₂—O—SO₂-p-C₆H₄—CH₃, —CH₂—O—SO₂—CF₃, C₁-C₆-alkoxy-carbonyl, C₆-C₁₀aryloxycarbonyl, C₁-C₆-alkanoyloxycarbonyl and

R⁷⁵ represents hydrogen, C₁-C₆-alkyl, C₅-C₆-cycloalkyl, C₇-C₁₅-aralkyl, C₁-C₆-alkoxycarbonyl, aryl.

Particularly great preference is given to compounds of the formula (IV)

in which

R⁶⁶, R⁶⁷, R⁶⁸ and R⁷¹ represent hydrogen,

R⁶⁹ and R⁷⁰ represent, independently of one another, hydrogen, methyl, C₁-C₂-alkoxy, chlorine, C₁-C₂-alkoxycarbonyl, mono- or di-C₁-C₄-alkylamino, C₁-C₄-alkanoyloxy,

R⁷² represents O or NH,

R⁷³ represents O

X⁶ represents cyano, C₁-C₆-alkoxycarbonyl, C₆-C₁₀-aryloxycarbonyl and

R⁷⁵ represents hydrogen, C₁-C₆-alkyl, C₅-C₆-cycloalkyl, C₇-C₁₅-aralkyl, C₁-C₆-alkoxycarbonyl, aryl.

The thermal cyclization product of the compound of the formula (IV) has the formula (IVa)

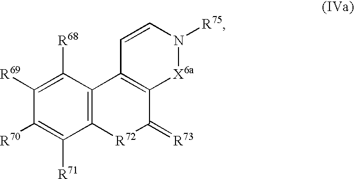

where

R⁶⁸-R⁷³ and R⁷⁵ are as defined above and

X^{6a} represents C═NH, CO or CH₂.

In a particularly preferred embodiment, the thermally cyclizable dye used is one of the formula (V),

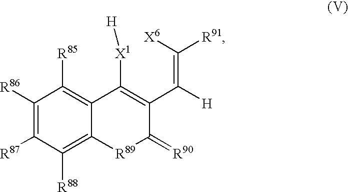

where

X¹ represents NR¹, O or S,

R¹ represents hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,

R⁸⁵, R⁸⁶, R⁸⁷, R⁸⁸ represent, independently of one another, hydrogen, methyl, ethyl, isopropyl, C₁-C₆-alkoxy, fluorine, chlorine, bromine, cyano, nitro, C₁-C₄-alkoxycarbonyl, mono- or di-C₁-C₄-alkylamino, C₁-C₄-alkanoyloxy or 2 adjacent radicals form a butadiene bridge,

R⁸⁷ may also represent 1,2,3-triazol-2-yl which may be benzo-fused or naphtho-fused in the 4, 5 position,

R⁸⁹ represents O, NH, N—C₁-C₃-alkyl,

R⁹⁰ represents O, N—C1-C6-alkyl or N—C₆-C₁₀-aryl,

R⁹¹ represents hydrogen, cyano or (C═R⁹³)R⁹⁴,

X⁶ represents CR⁹⁸R⁹⁹R¹⁰⁰, CR¹⁰¹═O, CR¹⁰²═S, CR¹⁰³═NR¹⁰⁴ or C≡N,

R⁹³ represents O, S or ═NR⁹⁵,

R⁹⁴ represents C₁-C₆-alkoxy, C₁-C₆-alkyl, C₁-C₆-alkanoyloxy, C₁-C₆-alkylthio, C₆-C₁₀-aryloxy, C₆-C₁₀-arylcarbonylamino, amino, N—C₁-C₆-alkylamino, di-N—C₁-C₆-alkylamino, N—C₁-C₆-alkyl-N—C₆-C₁₀-arylamino,

R⁹⁵ represents hydrogen, C₁-C₆-alkyl, C₁-C₆-alkenyl, C₄-C₇-cycloalkyl, C₇-C₁₅-aralkyl, C₁-C₆-alkoxycarbonyl, aryl,

R⁹⁸ represents hydrogen, bromine, chlorine, methoxy or ethoxy,

R⁹⁹ represents hydrogen, bromine, chlorine or represents methoxy when R⁹⁸ represents methoxy or represents ethoxy when R⁹⁸ represents ethoxy,

R¹⁰⁰ represents a leaving group such as bromine, chlorine, iodine, cyano, tosylate, triflate, C₁-C₆-alkanoyloxy, C₁-C₆-alkylthio or represents methoxy when R⁹⁹ represents methoxy or represents ethoxy when R⁹⁹ represents ethoxy,

R¹⁰¹, R¹⁰² and R¹⁰³ represent C₁-C₆-alkoxy, chlorine, bromine, iodine, C₁-C₆-alkanoyloxy, C₁-C₆-alkylthio, C₆-C₁₀-aryloxy, C₆-C₁₀-arylcarbonylamino and

R¹⁰⁴ represents hydrogen, C₁-C₆-alkyl, C₁-C₆-alkenyl, C₁-C₆-alkynyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals.

Very particular preference is given to compounds of the formula (V)

in which

X¹ represents NR¹, O or S,

R¹ represents hydrogen, C₁-C₆-alkyl, C₅-C₆-cycloalkyl, C₁-C₆-alkoxycarbonyl, aryl,

R⁸⁵ and R⁸⁸ represent hydrogen or

R⁸⁵ and R⁸⁶ may also form a butadiene bridge or

R⁸⁶ and R⁸⁷ represent, independently of one another, hydrogen, methyl, ethyl, isopropyl, C₁-C₆-alkoxy, chlorine, bromine, cyano, nitro, C₁-C₄-alkoxycarbonyl, mono- or di-C₁-C₄-alkylamino, C₁-C₄-alkanoyloxy, or

R⁸⁷ may also represent 1,2,3-triazol-2-yl which may be benzo-fused or naphtho-fused in the 4, 5 position,

R⁸⁹ represents O or NH,

R⁹⁰ represents O

R⁹¹ represents hydrogen, cyano or (C═R⁹³)R⁹⁴,

X⁶ represents CR⁹⁸R⁹⁹R¹⁰⁰, CR¹⁰¹═O, CR¹⁰²═S or C≡N.

R⁹³ represents O,

R⁹⁴ represents C₁-C₆-alkoxy, C₁-C₆-alkanoyloxy, C₆-C₁₀-aryloxy, C₆-C₁₀-arylcarbonylamino,

R⁹⁸ and R⁹⁹ represent hydrogen,

R¹⁰⁰ represents a leaving group such as bromine, chlorine, iodine, cyano, tosylate, triflate, C₁-C₆-alkanoyloxy, C₁-C₆-alkylthio and

R¹⁰¹ and R¹⁰² represent, independently of one another, C₁-C₆-alkoxy, chlorine, bromine, iodine, C₁-C₆-alkanoyloxy, C₁-C₆-alkylthio, C₆-C₁₀-aryloxy, C₆-C₁₀-arylcarbonylamino.

Particularly great preference is given to compounds of the formula (V)

in which

R¹ represents hydrogen, C₁-C₆-alkyl, C₅-C₆-cycloalkyl, C₁-C₆-alkoxycarbonyl, aryl,

X¹ represents NR¹,

R⁸⁵, R⁸⁸ represent hydrogen,

R⁸⁶, R⁸⁷ represent, independently of one another, hydrogen, methyl, C₁-C₄-alkoxy, chlorine, C₁-C₄-alkoxycarbonyl, C₁-C₄-dialkylamino, C₁-C₄-alkanoyloxy,

R⁸⁹ represents O or NH,

R⁹⁰ represents O,

R⁹¹ represents hydrogen or C₁-C₄-alkoxycarbonyl,

X⁶ represents CR¹⁰¹═O or C≡N,

R¹⁰¹ represents C₁-C₆-alkoxy, C₁-C₆-alkanoyloxy, C₁-C₆-alkylthio, C₆-C₁₀-aryloxy.

The thermal cyclization product of the compound of the formula (V) has the formula (Va)

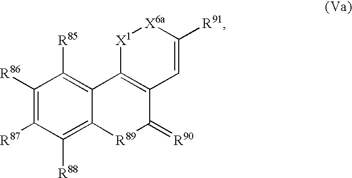

where

R¹, R⁸⁵-R⁹¹ and X¹ are as defined above and

X^{6a} represents CR⁹⁸R⁹⁹, CO, CS, C═NR¹⁰⁴ or C═NH.

In a likewise preferred embodiment, the light-absorbent compounds of the formula (I) which are used are ones of the formula (VI)

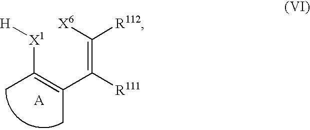

where

X¹ represents NR¹,

R¹ represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,

R¹¹¹ represents hydrogen, methyl, bromine, amino, N-methylamino, dimethylamino, methoxy, ethoxy, —S—CH₃,

R¹¹² represents cyano, C₁-C₆-alkoxycarbonyl, C₆-C₁₀aryloxycarbonyl, C₁-C₆-alkanoyloxycarbonyl, mono- or di-C₁-C₆-alkylaminocarboxamide, mono- or diarylaminocarboxamide, monoaryl-mono-C₁-C₆-alkylaminocarboxamide, carboxamide,

ring A represents a 5-9-membered, partially unsaturated, aromatic or pseudoaromatic ring which may contain 1-4 hetero atoms or carbonyl groups and/or may be benzo- or naphtho-fused and/or substituted by nonionic radicals and

X⁶ represents cyano, C₁-C₆-alkoxycarbonyl, C₆-C₁₀-aryloxycarbonyl or C₁-C₆-alkanoyloxycarbonyl.

Particularly great preference is given to compounds of the formula (VI) in which

X¹ represents NR¹,

R¹ represents C₁-C₆-alkyl, C₁-C₆-alkenyl, C₁-C₆-alkinyl, C₄-C₇-cycloalkyl, C₇-C₁₅-aralkyl, aryl or hetaryl, where the hetaryl radical can contain up to 3 hetero atoms and the aryl or hetaryl radical may be substituted by up to 3 nonionic radicals,

R¹¹¹ represents hydrogen, methyl, bromine, methoxy, ethoxy,

R¹¹² represents cyano, C₁-C₆-alkoxycarbonyl, C₆-C₁₀aryloxycarbonyl, C₁-C₆-alkanoyloxycarbonyl,

ring A represents a 5-7-membered, partially unsaturated, aromatic or pseudoaromatic ring which may contain 1-4 hetero atoms or carbonyl groups and/or may be benzo- or naphtho-fused and/or substituted by nonionic radicals and

X⁶ represents cyano, C₁-C₆-alkoxycarbonyl, C₆-C₁₀-aryloxycarbonyl.

Very particular preference is given to compounds of the formula (VI) in which

X¹ represents NR¹,

R¹ represents C₁-C₆-alkyl, C₁-C₆-alkenyl, C₅-C₇-cycloalkyl, C₇-C₁₅-aralkyl, aryl or hetaryl, where the hetaryl radical can contain up to 3 hetero atoms and the aryl or hetaryl radical may be substituted by up to 3 nonionic radicals,

R¹¹¹ represents hydrogen,

R¹¹² represents cyano, C₁-C₆-alkoxycarbonyl or C₆-C₁₀-aryloxycarbonyl,

ring A represents a 5-6-membered, partially unsaturated, aromatic or pseudoaromatic ring which may contain 1-4 hetero atoms or carbonyl groups and/or may be benzo- or naphtho-fused and/or substituted by nonionic radicals and

X⁶ represents cyano, C₁-C₆-alkoxycarbonyl, C₆-C₁₀-aryloxycarbonyl.

The thermal cyclization product of the compound of the formula (VI) has the formula (VIa)

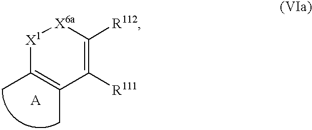

where

the radicals X¹, R¹¹¹ and R¹¹² are as defined above and

X^{6a} represents C═NH or C═O.

It is also possible to use mixtures of compounds of the formula (I), for example to optimize the physical properties of the information layer.

In the case of a write-once optical data carrier according to the invention which is written on and read by means of the light of a blue laser, preference is given to light-absorbent compounds whose absorption maximum λₘₐₓ is in the range from 350 to 470 nm and which have been converted into the closed-ring form above the cyclization temperature T_{cyc}.

Preference is given to light-absorbent compounds having a cyclization temperature T_{cyc} of at least 100° C., particularly preferably greater than or equal to 140° C., in particular greater than or equal to 180° C.

Preference is given to dyes in which the shift in the absorption maximum induced by thermal cyclization, Δλₘₐₓ, is 25 nm or more, preferably ≧35 nm, in particular ≧45 nm. If a preferably hypsochromic shift occurs, then Δλₘₐₓ is negative. For the purposes of the invention, the absorption maximum is the local maximum in the range from 350 to 470 nm; it is not necessarily the absolute maximum in the UV/VIS spectrum in the range from 190 to 800 nm.

The light-absorbent compounds preferably have a molar extinction coefficient ε of >20 000 l/mol cm, preferably >30 000 l/mol cm, particularly preferably >40 000 l/mol cm, very particularly preferably >50 000 l/mol cm, at the absorption maximum λₘₐₓ.

The absorption spectra are, for example, measured in solution.

Some compounds of the formula (I) which cyclize thermally to form 6-membered rings are known, for example from Arch. Pharm. 1987, 320, 577-581.

The light-absorbent compounds described, in particular those of the formula (I), guarantee a sufficiently high reflectivity (>10%) of the optical data carrier in the unwritten state and a sufficiently high absorption for thermal degradation of the information layer on point-wise illumination with focused light if the wavelength of the light is in the range from 360 to 460 nm. The contrast between written and unwritten points on the data carrier is achieved by the reflectivity change of the amplitude and also the phase of the incident light due to the changed optical properties of the information layer after the thermal degradation.

The light-absorbent compounds are preferably applied to the optical data carrier by spin coating. They can be mixed with one another or with other dyes having similar spectral properties. The information layer can comprise not only the light-absorbent compounds but also additives such as binders, wetting agents, stabilizers, diluents and sensitizers and also further constituents.

Apart from the information layer, further layers such as metal layers, dielectric layers and protective layers may be present in the optical data store. Metal and dielectric layers and/or the protective layer(s) serve, inter alia, to adjust the reflectivity and the heat absorption/retention. Metals can be, depending on the laser wavelength, gold, silver, aluminium, etc. Examples of dielectric layers are silicon dioxide and silicon nitride. Protective layers are, for example, photocurable surface coatings, (pressure-sensitive) adhesive layers and protective films. Pressure-sensitive adhesive layers consist mainly of acrylic adhesives. Nitto Denko DA-8320 or DA-8310, disclosed in the patent JP-A 11-273147, can, for example, be used for this purpose.

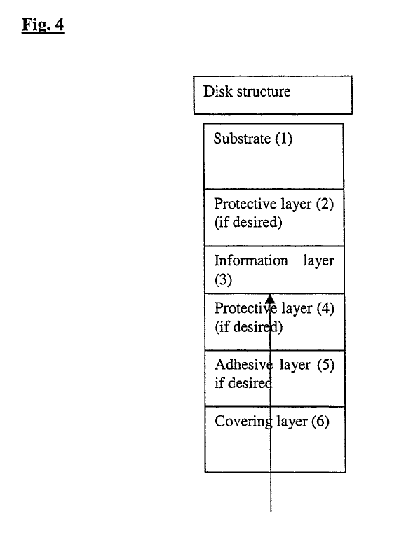

The optical data carrier has, for example, the following layer structure (cf. FIG. 4): a transparent substrate (1), if desired a protective layer (2), an information layer (3), if desired a protective layer (4), if desired an adhesive layer (5), a covering layer (6).

The structure of the optical data carrier preferably:

comprises a preferably transparent substrate (1) to whose surface at least one light-writeable information layer (3) which can be written on by means of light, preferably laser light, if desired a protective layer (4), if desired an adhesive layer (5) and a transparent covering layer (6) have been applied.

comprises a preferably transparent substrate (1) to whose surface a protective layer (2), at least one information layer (3) which can be written on by means of light, preferably laser light, if desired an adhesive layer (5) and a transparent covering layer (6) have been applied.

comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.

comprises a preferably transparent substrate (1) to whose surface at least one information layer (3) which can be written on by means of light, preferably laser light, if desired an adhesive layer (5) and a transparent covering layer (6) have been applied.

The invention further provides optical data carriers according to the invention which have been written on by means of blue light, in particular laser light.

The following examples illustrate the subject-matter of the invention.

### EXAMPLES

### Example 1

3.3 g of ethyl ethoxymethylenecyanoacetate were added to a solution of 4.0 g of 6,7-dimethoxy-3,4-dihydro-1-methylisoquinoline in dry methanol over a period of 30 minutes. The mixture was stirred at 25° C. for 3 hours and at 40° C. for 3 hours. The solid which had precipitated was filtered off with suction and washed with cold methanol. This gave 3.0 g (52% of theory) of orange powder of the formula (1):

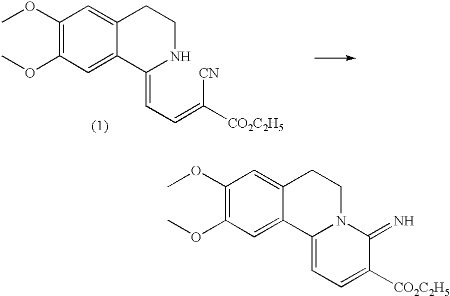

cyclization temperature T_{cyc}: 123° C. (determined using DTA, see description. This also applies to the other examples).

λₘₐₓ (methanol)=447 nm

ε=47 560 l/mol cm

solubility:>2% in TFP (2,2,3,3-tetrafluoropropanol)

absorption shift after cyclization: Δλₘₐₓ=−49 nm

glass-like film

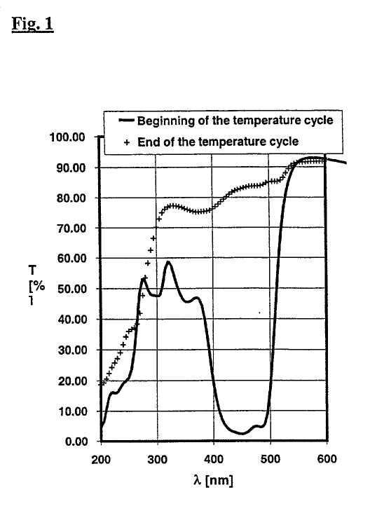

A 2% strength by weight solution of the dye in 2,2,3,3-tetrafluoropropanol was prepared at room temperature. This solution was applied by means of spin coating to a fused silica substrate. The resulting thickness of the dye film was about 150 nm. This specimen was heated from 50° C. to 133° C. in a stream of helium at a mean heating rate of 3 K/min and subsequently cooled to 81° C. at a mean cooling rate of 1.4 K/min. During the heating and cooling phases, transmission spectra of the specimen in the wavelength range from 200 nm to 1700 nm were recorded. The change in the optical properties resulting from the ring-closure reaction can be observed by looking at the transmission spectra at different temperatures. FIG. 1 shows the transmission spectra at the beginning and the end of the above-described temperature cycle.

The absorption band in the region of 450 nm obviously disappears virtually completely and leads to a change in the absorption properties which can be utilized in the wavelength range from 400 to 500 nm for the optical storage and reproduction of data, for example when a laser beam having an appropriate pulse duration and pulse energy heats the dye layer to above 133° C. Furthermore, each absorption also produces a dispersion of the index of refraction over the wavelength. This leads, in particular on the flanks of the absorption bands, to indices of refraction which are lower (short wavelength flank) or higher (long wavelength flank) than 1.4-1.6, which represents the usual range for colourless organic materials. For example, the index of refraction of the dye at 405 nm is 1.17 at the beginning of the temperature cycle and that at 515 nm is 2.17 nm. After the temperature cycle, when the absorption band has disappeared virtually completely, the decolourized dye has an index of refraction in the range from 1.4 to 1.6 in the visible spectrum. This change in the index of refraction can likewise be utilized for the optical storage and reproduction of data, for example when a laser beam having an appropriate pulse duration and pulse energy heats the dye layer to above 133° C. Changes in the index of refraction and/or the absorption alter the reflection and/or transmission properties of thin films on a transparent substrate (glass or polymer) and can therefore be transformed into changes in the amount of reflected and/or transmitted light by a laser beam which is scanned over such markings written by means of a pulsed and focused laser beam. The relevant film thicknesses are preferably in the range from 10 nm to 2000 nm.

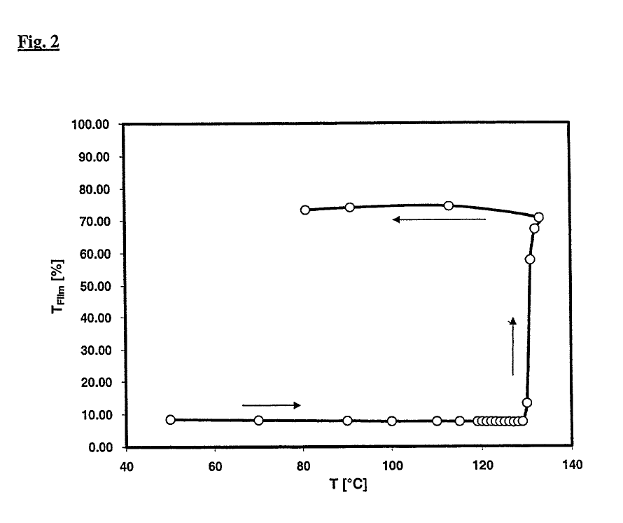

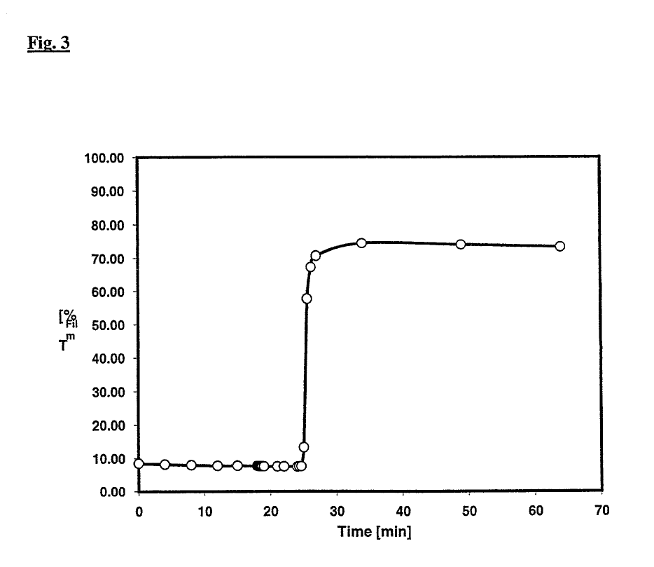

FIG. 2 and FIG. 3 show, by way of example, the change in the transmission of the above-described specimen at 405 nm during the temperature cycle. FIG. 2 shows the transmission as a function of temperature and FIG. 3 shows it as a function of time. It is clear that the ring-closure reaction takes place in a very narrow temperature and time window and is therefore suitable for writing data at high speed and with little blurring of the margins by means of a focused and pulsed laser beam which is scanned across the specimen. The laser wavelength is, for reasons mentioned above, preferably in the range from 360 nm to 600 nm, particularly preferably in the range from 380 nm to 550 nm.

### Example 2

4 g of p-t-butylaniline and 3 g of cis-4-(2-dimethylaminoethenyl)-2-oxo-1,2-dihydro-quinoline-3-carbonitrile were added to 15 ml of glacial acetic acid and the mixture was stirred at 60° C. for 6 hours. The solid was filtered off with suction and recrystallized from glacial acetic acid. This gave 3.90 g (95%) of an orange powder (2):

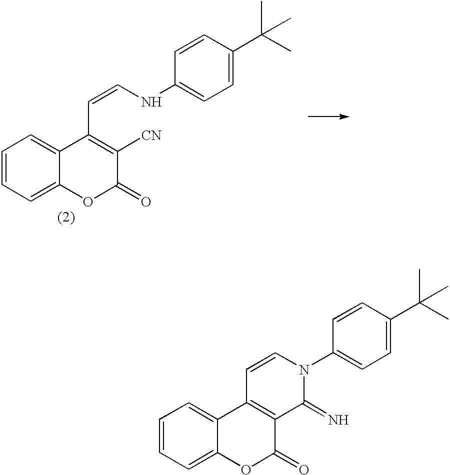

cyclization temperature T_{cyc}: 141° C.

λₘₐₓ (DMF)=464 nm

ε=30 620 l/mol cm

solubility: 1% in TFP (2,2,3,3-tetrafluoropropanol)

Absorption shift after cyclization: ελₘₐₓ=>|100|nm (the rearranged product decomposes and turns brown; for this reason, no local maximum in the range 360-560 nm can be detected).

glass-like film

### Example 3

6.8 g of isopropylamine were added to a suspension of 10.0 g of 4-chloro-7-ethyl-3-(2′-methoxycarbonyl)vinylcoumarin in ethanol and the mixture was refluxed for 6 hours. On cooling, a solid precipitated from the solution and this was purified chromatographically using toluene/methanol. This gave 7.3 g (67% of theory) of a pale yellow powder of the formula (3):

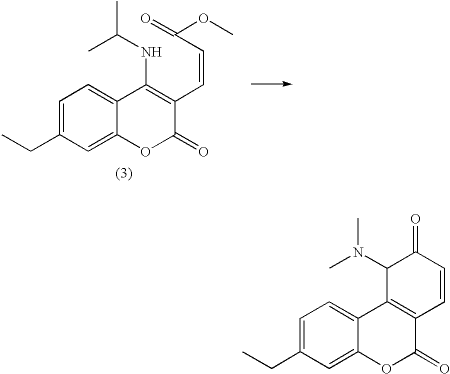

cyclization temperature T_{cyc}: 206° C.

λₘₐₓ (methanol)=359 nm

ε=20 700 l/mol cm

solubility: 1% in TFP (2,2,3,3-tetrafluoropropanol)

absorption shift after cyclization: Δλₘₐₓ=−20 nm

glass-like film

### Example 4

A solution of 3.7 g of ethyl ethoxymethylenecyanoacetate in 10 ml of methanol is added dropwise at 25° C. to a solution of 3 g of cyclopentyl-N-butylimine in 10 ml of methanol over a period of 30 minutes. After about 1 hour, an orange-yellow solid precipitates and is filtered off and washed with petroleum ether. Yield: 4.2 g (77%) of dye (4):

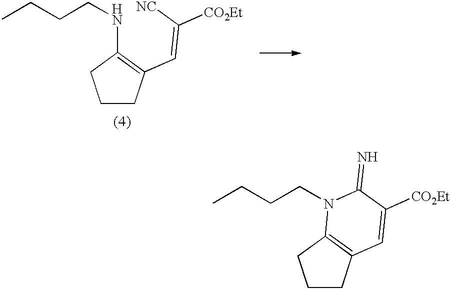

cyclization temperature T_{cyc}: 198° C.

λₘₐₓ (methanol)=441 nm

cε=36 910 l/mol cm

solubility: >2% in TFP (2,2,3,3-tetrafluoropropanol)

absorption shift after cyclization: ελₘₐₓ=−72 nm

glass-like film

Further suitable dyes which cyclize thermally to form 5-7-membered rings are shown in the following tables:

| Ex. | | R⁴⁵ | R⁴⁶ | R⁴⁷ | R⁴⁸ | R⁴⁹ | R⁵⁰ | R⁵¹ | R⁵² | X⁶ | λₘₐₓ | Δλₘₐₓ | ε | T_{cyc} |
|---|---|---|---|---|---|---|---|---|---|---|---|---|---|---|
| 5 | 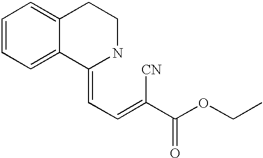 | H | H | H | H | H | H | H | CO₂C₂H₅ | CN | 440 | −46 | 53 320 | 124 |
| 6 | Error! No valid | H | H | OCH₃ | OCH₃ | H | H | H | CO₂C₂H₅ | CO₂C₂H₅ | 441 | −60 | 39 550 | 50 |
| | connection. | | | | | | | | | | | | | |
| 7 | Error! No valid | H | H | OCH₃ | OCH₃ | H | H | H | CN | CN | 447 | −43 | 38 080 | 136 |
| | connection. | | | | | | | | | | | | | |
| 8 | 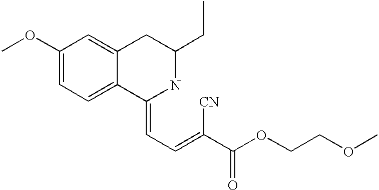 | C₂H₅ | H | OCH₃ | H | H | H | H | CO₂CH₂—CH₂OCH₃ | CN | 444 | −50 | 37 520 | 212 |
| 9 | 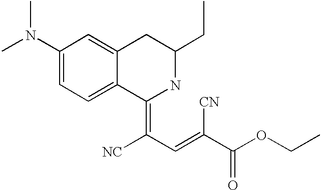 | C₂H₅ | H | N(CH₃)₂ | H | H | CN | H | CO₂C₂H₅ | CN | 452 | −53 | 63 160 | 207 |
| 10 | Error! No valid | H | H | N(CH₃)₂ | H | H | H | CH₃ | CN | CN | 451 | −51 | 65 040 | 148 |
| | connection. | | | | | | | | | | | | | |

Examples of compounds of the formula (III)

| Ex. | | R⁷⁵ | R⁶⁶ | R⁶⁷ | R⁶⁸ | R⁶⁹ | R⁷⁰ | R⁷¹ | R⁷² | R⁷³ | X⁶ | λₘₐₓ | Δλₘₐₓ | ε | T_{cyc} |
|---|---|---|---|---|---|---|---|---|---|---|---|---|---|---|---|
| 11 | 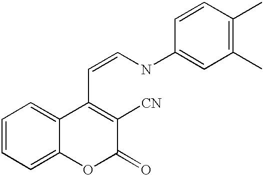 | —C₆H₃-m-CH₃p CH₃ | H | H | H | H | H | H | O | O | CN | 467 | >\|100\|* | 30 820 | 157 |
| 12 | 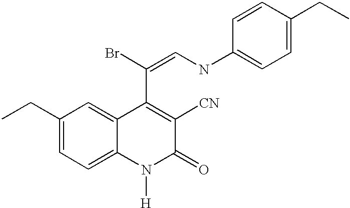 | —C₆H₄-p-C₂H₅ | H | Br | H | C₂H₅ | H | H | NH | O | CN | 463 | >\|100\|* | 32 140 | 161 |
| 13 | 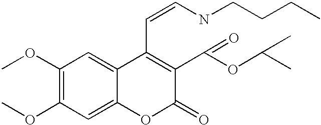 | —CH₂CH₂—CH₂CH₃ | H | H | H | OCH₃ | OCH₃ | H | O | O | CO₂—C₃H₇ | 422 | −50 | 24 580 | 81 |
| 14 | 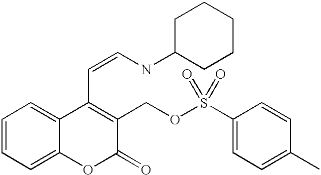 | —C₆H₁₁ | H | H | H | H | H | H | O | O | —CH₂—SO₂C₆H₄-p-CH₃ | 368 | −15 | 21 750 | 175 |
| 15 | 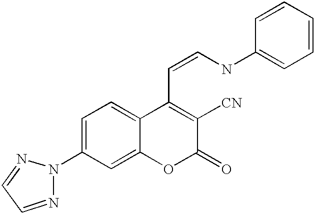 | —C₆H₅ | H | H | H | H | 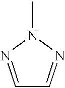 | H | O | O | CN | 468 | >\|100\|* | 38 540 | 146 |

Examples of compounds of the formula (IV)
*The rearranged product decomposes and turns brown; no local maximum in the range 360-560 nm can be detected

| Ex. | | X¹ | R⁸⁵ | R⁸⁶ | R⁸⁷ | R⁸⁸ | R⁸⁹ | R⁹⁰ | R⁹¹ | X⁶ | λₘₐₓ | Δλₘₐₓ | ε | T_{cyc} |
|---|---|---|---|---|---|---|---|---|---|---|---|---|---|---|
| 16 | 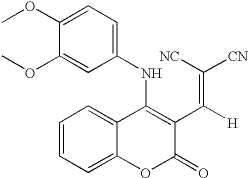 | —N—C₆H₃—m-OCH₃p OCH₃ | H | H | H | H | O | O | CN | CN | 386 | −38 | 26 670 | 167 |

Example of compounds of the formula (V)

| Ex. | | X¹ | A | R¹¹¹ | R¹¹² | X⁶ | λₘₐₓ | Δλₘₐₓ | ε | T_{cyc} |
|---|---|---|---|---|---|---|---|---|---|---|
| 17 | 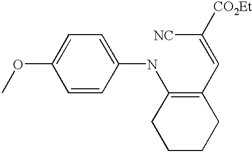 | N—C₆H₄-p-OCH₃ | —CH₂—CH₂—CH₂—CH₂— | H | —CO₂C₂H₅ | CN | 445 | −65 | 33 200 | 176 |
| 18 | 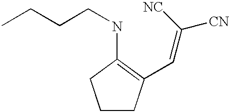 | —N—(CH₂)₃—CH₃ | —CH₂CH₂CH₂— | H | CN | CN | 440 | −70 | 37 840 | 174 |

Examples of compounds of the formula (VI)

1. Optical data carrier comprising a preferably transparent substrate which may, if desired, have previously been coated with a protective layer and to whose surface a light-writable information layer, if desired a protective layer, if desired an adhesive layer and finally a covering layer have been applied, which can be written on and read by means of blue light, preferably laser light, where the information layer comprises a light-absorbent compound, characterized in that the light-absorbent compound has a chemical structure which cyclizes thermally to 5-, 6- or 7-membered rings during the writing process.

2. Optical data carrier according to claim 1, characterized in that the light-absorbent compound has the formula (I) or (II), 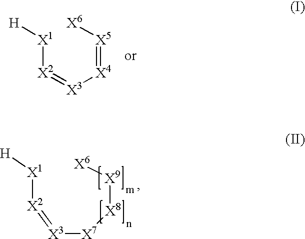
steht,
where
X¹ represents NR¹, O or S,
x² represents CR² or N,
x³ represents CR³ or N,
X⁴ represents CR⁴ or N,
X⁵ represents CR⁵ or N, where the sequence X²-X³-X⁴-X⁵ has no adjacent N atoms,
x⁶ represents CR⁶R⁷R⁸, CR⁹═O, CR¹⁰═S, CR¹¹═NR¹² or C≡N,
X⁷ represents CR¹³ R¹⁴ or C═R¹⁵,
X⁸ represents O, NR¹⁶, CR¹⁷R¹⁸ or C═R¹⁹,
X⁹ represents O, NR²⁰, CR²¹R²² or C═R²³, where X⁹ does not represent O when X⁸ represents O,
n,m represent, independently of one another, 0 or 1,
R¹ represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,
R² represents hydrogen, bromine, C₁-C₆-alkyl, C₁-C₆-alkenyl, C₁-C₆-alkinyl, C₆- C₁₀-aryl, C₇-C₁₅-araryl, hetaryl, C₁-C₆-alkoxy, mono- or di-C₁-C₆-alkyl amino, N—C₁-C₆-alkyl-N—C₆-C₁₀-arylamino or together with R¹ is part of a five- or 6-membered aromatic or partially hydrogenated ring which may contain from 1 to 4 hetero atoms or carbonyl groups and/or may be benzo- or naphtho-fused and/or substituted by nonionic, preferably electron donor radicals,
R³ represents hydrogen, C₁-C₆-alkyl, C₁-C₆-alkenyl, C₆-C₁₀-aryl, C₇-C₁₅-araryl, hetaryl, C₁-C₆-alkoxycarbonyl, formyl, cyano, nitro, halogen or together with R² is part of a five- or 6-membered aromatic or partially hydrogenated ring which may contain from 1 to 4 hetero atoms or carbonyl groups and/or may be benzo- or naphtho-fused and/or have its rings substituted by nonionic radicals,
R⁴ represents hydrogen, amino, bromine, C₁-C₆-alkyl, C₁-C₆-alkenyl, C₁-C₆-alkinyl, C₆-C₁₀-aryl, C₇-C₁₅-araryl, hetaryl, C₁-C₆-alkoxy, C₁-C₆-thioalkoxy, mono- or di-C₁-C₆-alkylamino, N—C₁-C₆-alkyl-N—C₆-C₁₀-arylamino or together with R³ is part of a five- or 6-membered aromatic or partially hydrogenated ring which may contain from 1 to 4 hetero atoms or carbonyl groups and/or may be benzo- or naphtho-fused and/or substituted by nonionic, preferably electron donor radicals,
R⁵ represents hydrogen or an electron acceptor, in particular cyano, nitro, —(C═R²⁴)R²⁵, a cationic radical such as ammonium or pyridinium or together with R⁴ is part of a five- or 6-membered aromatic or partially hydrogenated ring which may contain up to 4 hetero atoms or carbonyl groups and/or may be benzo- or naphtho-fused and/or substituted by nonionic radicals,
R⁶ represents hydrogen, bromine, chlorine, methoxy or ethoxy,
R⁷ represents hydrogen, bromine, chlorine or represents methoxy when R⁶ represents methoxy or represents ethoxy when R⁶ represents ethoxy,
R⁸ represents bromine, chlorine, iodine, cyano, tosylate, triflate, C₁-C₆-alkanoyloxy, C₁-C₆-alkylthio or represents methoxy when R⁷ represents methoxy or represents ethoxy when R⁷ represents ethoxy,
R⁹, R¹⁰ and R¹¹ represent, independently of one another, C₁-C₆-alkoxy, chlorine, bromine, iodine, C₁-C₆-alkanoyloxy, C₁-C₆-alkylthio, C₆-C₁₀-aryloxy, C₆-C₁₀-arylcarbonylamino or one of these radicals together with R⁵ is part of a five- or 6-membered aromatic or partially hydrogenated ring which may contain carbonyl groups or from 1 to 4 hetero atoms and/or may be benzo- or naphtho-fused and/or substituted by nonionic radicals,
R¹² represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,
R¹³, R¹⁴, R¹⁷, R¹⁸, R²¹ and R²² represent, independently of one another, hydrogen, C₁-C₃-alkyl, fluorine, chlorine or bromine,
R¹⁵ represents O, S, ═NR²⁶ or CR²⁷R²⁸,
R¹⁶ and R²⁰ represent, independently of one another, hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,
R¹⁹ represents O, S, ═NR²⁹ or CR³⁰R³¹,
R²³ represents O, S, ═NR³², CR³³R³⁴,
R²⁴ represents O, S or NR³⁵,
R²⁵ represents bromine, amino, N—C₁-C₆-alkylamino, di-N—C₁-C₆-alkylamino, N—C₁-C₆-alkyl-N—C₆-C₁₀-arylamino, C₁-C₆-alkanoyloxy, C₆-C₁₀-aryloxy, C₁-C₆-alkyl, C₁-C₆-alkoxy, C₁-C₆-alkylthio or together with X⁶ is part of a 5- or 6-membered ring,
R²⁶, R²⁹, R³² and R³⁵ represent, independently of one another, hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals and
R²⁷, R²⁸, R³⁰, R³¹, R³³ and R³⁴ represent, independently of one another, hydrogen, C₁-C₆-alkyl, C₁-C₆-alkenyl, C₄-C₇-cycloalkyl, C₇-C₁₅-aralkyl, aryl or hetaryl, where the hetaryl radical can contain up to 3 hetero atoms and the aryl or hetaryl radical may be substituted by up to 3 nonionic radicals.

3. Optical data carrier according to claim 1 or 2, characterized in that the light-absorbent compound used is a compound of the formula (III), 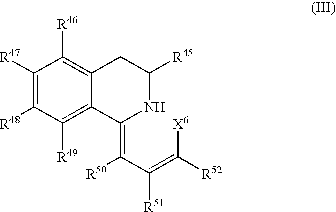
where
R⁴⁵ represents hydrogen, bromine, chlorine, C₁-C₄-alkyl, C₁-C₄-alkoxy, cyano, C₁-C₄-alkoxycarbonyl, mono- or di-C₁-C₄-alkylamino,
R⁴⁶, R⁴⁷, R⁴⁸ and R⁴⁹ represent, independently of one another, hydrogen, methyl, ethyl, C₁-C₆-alkoxy, fluorine, chlorine, bromine, cyano, nitro, C₁-C₄-alkoxycarbonyl, mono- or di-C₁-C₄-alkylamino,
R⁵⁰ represents hydrogen, methyl, cyano, C₁-C₆-alkoxycarbonyl, formyl, bromine, chlorine,
R⁵¹ represents hydrogen, methyl, bromine, amino, N-methylamino, dimethylamino, methoxy, ethoxy, —S—CH₃,
R⁵² represents cyano, C₁-C₆-alkoxycarbonyl, C₆-C₁₀-aryloxycarbonyl, C₁-C₆-alkanoyloxycarbonyl and
X⁶ represents cyano, C₁-C₆-alkoxycarbonyl, C₆-C₁₀aryloxycarbonyl, C₁-C₆-alkanoyloxycarbonyl or —CH₂—O—SO₂-p-C₆H₄—CH₃.

4. Optical data carrier according to claim 1 or 2, characterized in that the light-absorbent compound used is a compound of the formula (IV) 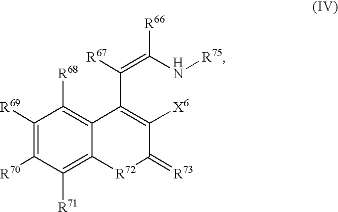
where
R⁶⁶ represents hydrogen, bromine, chlorine, C₁-C₄-alkyl, C₁-C₆-alkoxy, cyano, C₁-C₄-alkoxycarbonyl, mono- or di-C₁-C₄-alkylamino,
R⁶⁷ represents hydrogen, C₁-C₆-alkyl, C₁-C₆-alkenyl, C₆-C₁₀-aryl, C₇-C₁₅-araryl, hetaryl, C₁-C₆-alkoxycarbonyl, formyl, cyano, nitro, halogen or together with R⁶⁶ is part of a five- or 6-membered aromatic or partially hydrogenated ring which may contain from 1 to 4 hetero atoms and/or may be benzo- or naphtho-fused and/or have its rings substituted by nonionic radicals,
R⁶⁸, R⁶⁹, R⁷⁰ and R⁷¹ represent, independently of one another, hydrogen, methyl, ethyl, isopropyl, C₁-C₆-alkoxy, fluorine, chlorine, bromine, cyano, nitro, C₁-C₄-alkoxycarbonyl, mono- or di-C₁-C₄-alkylamino, C₁-C₄-alkanoyloxy or 2 adjacent radicals form a butadiene bridge,
R⁷⁰ may also represent 1,2,3-triazol-2-yl which may be benzo-fused or naphtho-fused in the 4,5 position,
R⁷² represents O, NH, N—C₁-C₃-alkyl,
R⁷³ represents O, N—C₁-C₆-alkyl, N—C₆-C₁₀-aryl,
X⁶ represents cyano, —CH₂—O—SO₂-p-C₆H₄—CH₃, —CH₂—O—SO₂—CF₃, C₁-C₆-alkoxy-carbonyl, C₆-C₁₀-aryloxycarbonyl, C₁-C₆-alkanoyloxycarbonyl and
R⁷⁵ represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals.

5. Optical data carrier according to claim 1 or 2, characterized in that the light-absorbent compound used is one of the formula (V) 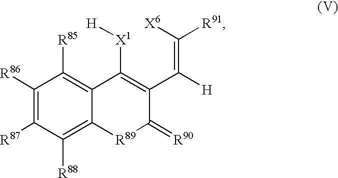
where
X¹ represents NR¹, O or S,
R¹ represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,
R⁸⁵, R⁸⁶, R⁸⁷, R⁸⁸ represent, independently of one another, hydrogen, methyl, ethyl, isopropyl, C₁-C₆-alkoxy, fluorine, chlorine, bromine, cyano, nitro, C₁-C₄-alkoxycarbonyl, mono- or di-C₁-C₄-alkylamino, C₁-C₄-alkanoyloxy or 2 adjacent radicals form a butadiene bridge,
R⁸⁷ may also represent 1,2,3-triazol-2-yl which may be benzo-fused or naphtho-fused in the 4,5 position,
R⁸⁹ represents O, NH, N—C₁-C₃-alkyl,
R⁹⁰ represents O, N—C₁-C₆-alkyl or N—C₆-C₁₀-aryl,
R⁹¹ represents hydrogen, cyano or (C═R⁹³)R⁹⁴,
X⁶ represents CR⁹⁸R⁹⁹R¹⁰⁰, CR¹⁰¹═O, CR¹⁰²═S, CR¹⁰³═NR¹⁰⁴ or C≡N,
R⁹³ represents O, S or ═NR⁹⁵,
R⁹⁴ represents C₁-C₆-alkoxy, C₁-C₆-alkyl, C₁-C₆-alkanoyloxy, C₁-C₆-alkylthio, C₆-C₁₀-aryloxy, C₆-C₁₀-arylcarbonylamino, amino, N—C₁-C₆-alkylamino, di-N—C₁-C₆-alkylamino, N—C₁-C₆-alkyl-N—C₆-C₁₀-arylamino,
R⁹⁵ represents hydrogen, C₁-C₆-alkyl, C₁-C₆-alkenyl, C₄-C₇-cycloalkyl, C₇-C₁₅-aralkyl, C₁-C₆-alkoxycarbonyl, aryl,
R⁹⁸ represents hydrogen, bromine, chlorine, methoxy or ethoxy,
R⁹⁹ represents hydrogen, bromine, chlorine or represents methoxy when R⁹⁸ represents methoxy or represents ethoxy when R⁹⁸ represents ethoxy,
R¹⁰⁰ represents a leaving group such as bromine, chlorine, iodine, cyano, tosylate, triflate, C₁-C₆-alkanoyloxy, C₁-C₆-alkylthio or represents methoxy when R⁹⁹ represents methoxy or represents ethoxy when R⁹⁹ represents ethoxy,
R¹⁰¹, R¹⁰² and R¹⁰³ represent C₁-C₆-alkoxy, chlorine, bromine, iodine, C₁-C₆-alkanoyloxy, C₁-C₆-alkylthio, C₆-C₁₀-aryloxy, C₆-C₁₀-arylcarbonyl-amino and
R¹⁰⁴ represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals.

6. Optical data carrier according to claim 1 or 2, characterized in that the light-absorbent compound used is a compound of the formula (VI) 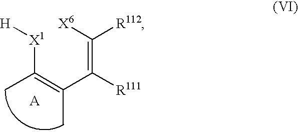
where
X¹ represents NR¹,
R¹ represents hydrogen, C₁-C₆-alkyl, C₁-C₆-alkenyl, C₁-C₆-alkinyl, C₄-C₇-cycloalkyl, C₇-C₁₅-aralkyl, C₁-C₆-alkoxycarbonyl, aryl or hetaryl, where the hetaryl radical can contain up to 3 hetero atoms and the aryl or hetaryl radical may be substituted by up to 3 nonionic radicals,
R¹¹¹ represents hydrogen, methyl, bromine, amino, N-methylamino, dimethylamino, methoxy, ethoxy, —S—CH₃,
R¹¹² represents cyano, C₁-C₆-alkoxycarbonyl, C₆-C₁₀-aryloxycarbonyl, C₁-C₆-alkanoyloxycarbonyl, mono- or di-C₁-C₆-alkylaninocarboxamide, mono- or diarylaminocarboxamide, monoaryl-mono-C₁-C₆-alkylaminocarboxamide, carboxamide,
ring A represents a 5-9-membered, partially unsaturated, aromatic or pseudoaromatic ring which may contain 1-4 hetero atoms or carbonyl groups and/or may be benzo- or naphtho-fused and/or substituted by nonionic radicals and
X⁶ represents cyano, C₁-C₆-alkoxycarbonyl, C₆-C₁₀-aryloxycarbonyl or C₁-C₆-alkanoyloxycarbonyl.

7. Use of light-absorbent compounds which have a chemical structure which cyclizes thermally to form 5-, 6- or 7-membered rings in the information layer of write-once optical data carriers, where the light-absorbent compounds have an absorption maximum λₘₐₓ in the range from 350 to 460 nm.

8. Use according to claim 7, characterized in that the thermally cyclizable dyes in the information layer of write-once optical data carriers are written on and read by means of blue laser light.

9. Process for producing the optical data carriers according to claim 1, which is characterized in that a preferably transparent substrate which may, if desired, have previously been coated with a reflection layer is coated with the thermally cyclizable dyes, if desired in combination with suitable binders and additives and, if desired, suitable solvents, and is, if desired, provided with a reflection layer, further intermediate layers and, if desired, a protective layer or a further substrate or a covering layer.

10. Optical data carriers according to claim 1 which can be written on by means of blue light, in particular blue laser light.

11. Compounds of the formula (III) 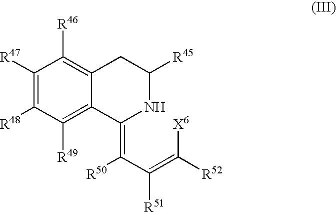
where
R⁴⁵ represents hydrogen, bromine, chlorine, C₁-C₄-alkyl, C₁-C₄-alkoxy, cyano, C₁-C₄-alkoxycarbonyl, mono- or di-C₁-C₄-alkylamino,
R⁴⁶, R⁴⁷, R⁴⁸ and R⁴⁹ represent, independently of one another, hydrogen, methyl, ethyl, C₁-C₆-alkoxy, fluorine, chlorine, bromine, cyano, nitro, C₁-C₄-alkoxycarbonyl, mono- or di-C₁-C₄-alkylamino,
R⁵⁰ represents hydrogen, methyl, cyano, C₁-C₆-alkoxycarbonyl, formyl, bromine, chlorine,
R⁵¹ represents hydrogen, methyl, bromine, amino, N-methylamino, dimethylamino, methoxy, ethoxy, —S—CH₃,
R⁵² represents cyano, C₁-C₆-alkoxycarbonyl, C₆-C₁₀aryloxycarbonyl, C₁-C₆-alkanoyloxycarbonyl and
X⁶ represents cyano, C₁-C₆-alkoxycarbonyl, C₆-C₁₀-aryloxycarbonyl, C₁-C₆-alkanoyloxycarbonyl or —CH₂—O—SO₂-p-C₆H₄—CH₃.

12. Compounds of the formulae (Ia) or (IIa) 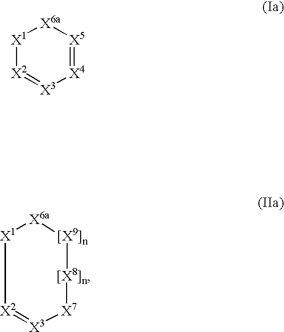
where
X¹, X², X³, X⁴, X⁵, X⁷, X⁸, X⁹, n and m are as defined in claim 2,
X^{6a} represents CR⁶R⁷, CO, CS, C═NR¹² or C═NH,
where
R⁶, R⁷ and R¹² are as defined in claim 2.

13. Optical data carrier comprising a compound of the formula (Ia) or (IIa) according to claim 12 as light-absorbent compound in the information layer.
